(19) United States
(12) Patent Application Publication
(10) Pub. No.: US 2026/0327414 A1
(43) Pub. Date: Oct. 22, 2026

(54) METHOD FOR MANUFACTURING RESIN-MOLDED ARTICLE

(71) Applicants: YAMAHA HATSUDOKI KABUSHIKI KAISHA, Iwata-shi, Shizuoka (JP); NIPPON PAPER INDUSTRIES CO., LTD., Tokyo (JP)

(72) Inventors: Takeshi OISHI, Shizuoka (JP); Hiroaki TAKAHASHI, Shizuoka (JP); Io KAKUTA, Tokyo (JP); Nobuhiko YAMAMOTO, Tokyo (JP)

(21) Appl. No.: 19/101,451

(22) PCT Filed: Nov. 10, 2023
(86) PCT No.: PCT/JP2023/040592

§ 371 Date: Feb. 5, 2025

(30) Foreign Application Priority Data
Nov. 15, 2022 (JP) 2022-182938

(51) Int. Cl. C08L 23/12; B29B 13/06; B29K 23/00; B29K 105/12; B29K 201/00

(52) U.S. Cl. CPC C08L 23/12; B29B 13/06; B29K 2023/12; B29K 2105/124; B29K 2201/00; C08L 2205/16

(57) ABSTRACT

A method for manufacturing a resin-molded article includes: preparing a resin composition containing thermoplastic resin and cellulose nanofibers; drying the resin composition; and subsequently molding the resin composition into the resin-molded article.

### TECHNICAL FIELD

The present invention relates to a method for manufacturing a resin-molded article.

### BACKGROUND ART

In recent years, cellulose nanofibers have been attracting attention, which are obtained by unraveling cellulose fibers to nano-size. Cellulose fiber is a biomass made from pulp derived from plants such as wood, and using it effectively is expected to reduce the environmental burden.

One application of cellulose nanofibers is to improve the strength of resin materials by dispersing cellulose nanofibers in resin. Resin compositions containing cellulose nanofibers are disclosed, for example, in Patent Document 1.

### CITATION LIST

### Patent Literature

Patent Document No. 1: Japanese Laid-Open Patent Publication No. 2019-131774

### SUMMARY OF INVENTION

### Technical Problem

According to a study by the present inventors, when resin-molded articles are molded from a resin composition containing cellulose nanofibers, silver white streaks, called silver streaks, are likely to occur on the obtained resin-molded articles. Silver streaks are a cosmetic defect that requires countermeasures.

An embodiment of the present invention has been made in view of the above problem, an object of which is to suppress the generation of silver streaks in a method for manufacturing resin-molded articles using a resin composition containing cellulose nanofibers.

### Solution to Problem

The present specification discloses a method for manufacturing a resin-molded article as set forth in the following items.

### [Item 1]

A method for manufacturing a resin-molded article including:
a step (A) of preparing a resin composition containing thermoplastic resin and cellulose nanofibers; and
a step (B) of molding the resin composition into a resin-molded article,
wherein the method further includes, before the step (B), a step (C) of drying the resin composition.

As the manufacturing method according to the embodiment of the present invention includes, before the step (B) of molding the resin composition into a resin-molded article, the step (C) of drying the resin composition, it is possible to perform the step (B) after the moisture content of the resin composition is reduced. Therefore, it is possible to suppress the generation of silver streaks caused by the moisture contained in the resin composition.

### [Item 2]

The method for manufacturing a resin-molded article according to item 1, wherein the step (C) is performed so that moisture content of the resin composition is 400 mass ppm or less.

From the viewpoint of more reliably suppressing the generation of silver streaks, it is preferred that the step (C) be performed so that the moisture content of the resin composition is 400 mass ppm or less.

### [Item 3]

The method for manufacturing a resin-molded article according to item 1, wherein the step (C) is performed so that moisture content of the resin composition is 240 mass ppm or less.

From the viewpoint of more reliably suppressing the generation of silver streaks, it is more preferred that the step (C) be performed so that the moisture content of the resin composition is 240 mass ppm or less.

### [Item 4]

The method for manufacturing a resin-molded article according to any one of items 1 to 3, wherein the step (C) is performed at a temperature of 100° C. or higher.

From the viewpoint of sufficiently reducing the moisture content of the resin composition, it is preferred that the step (C) be performed at a certain temperature or higher, specifically, it is preferred that the step (C) be performed at a temperature of 100° C. or higher.

### [Item 5]

The method for manufacturing a resin-molded article according to any one of items 1 to 4, wherein the step (C) is performed for 1 hour or longer.

From the viewpoint of sufficiently reducing the moisture content of the resin composition, it is preferred that the step (C) be performed for a certain amount of time or longer, specifically, it is preferred that the step (C) be performed for 1 hour or longer.

### [Item 6]

The method for manufacturing a resin-molded article according to any one of items 1 to 5, wherein the thermoplastic resin is polypropylene.

For example, polypropylene can be suitably used as the thermoplastic resin contained in the resin composition.

### [Item 7]

The method for manufacturing a resin-molded article according to any one of items 1 to 6, wherein an average fiber diameter of the cellulose nanofibers is 10 nm or more and 100 nm or less.

The average fiber diameter of the cellulose nanofibers contained in the resin composition is preferably 10 nm or more and 100 nm or less.

### [Item 8]

The method for manufacturing a resin-molded article according to any one of items 1 to 7, wherein an average fiber length of the cellulose nanofibers is 10 μm or more and 100 μm or less.

The average fiber length of the cellulose nanofibers contained in the resin composition is preferably 10 μm or more and 100 μm or less.

### Advantageous Effects of Invention

An embodiment of the present invention is a method for manufacturing a resin-molded article using a resin composition containing cellulose nanofibers, wherein it is possible to suppress the generation of silver streaks.

### BRIEF DESCRIPTION OF DRAWINGS

FIG. 1 is a flow chart showing a method for manufacturing a resin-molded article according to an embodiment of the present invention.

FIG. 2 shows the results of checking for the presence of silver streaks for samples #1-1, #1-2, #1-3, #5-1, #5-2, #5-3, #8-1, and #8-2, along with external visual images thereof.

FIG. 3 is a graph showing the relationship between drying time and moisture content.

FIG. 4 shows the results of checking for the presence of silver streaks for samples #12-1 to #12-10, along with external visual images thereof.

FIG. 5 is a graph showing the relationship between drying time and moisture content.

FIG. 6 is a flow chart showing an example of a method for manufacturing a resin composition.

FIG. 7 shows an engine cover 1 and a crossbar member 10 for a watercraft.

### DESCRIPTION OF EMBODIMENTS

An embodiment of the present invention will be described with reference to the drawings. Note that the present invention is not limited to the following embodiment.

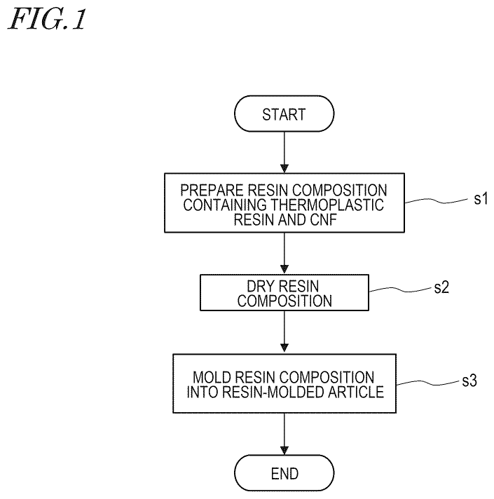

With reference to FIG. 1, a method for manufacturing a resin-molded article according to an embodiment of the present invention will be described. FIG. 1 is a flow chart showing a method for manufacturing a resin-molded article.

First, a resin composition containing a thermoplastic resin and cellulose nanofibers (CNF) is prepared (step s1). For example, polypropylene can be suitably used as the thermoplastic resin contained in the resin composition, but thermoplastic resins other than polypropylene (e.g., nylon) may also be used. Note that the resin composition may contain components other than a thermoplastic resin and cellulose nanofibers (e.g., a dispersing agent).

Cellulose nanofibers are fibers having a nano-sized diameter obtained by unraveling cellulose fibers. The average fiber diameter of the cellulose nanofibers contained in the resin composition is preferably 10 nm or more and 100 nm or less. The average fiber length of the cellulose nanofibers in the resin composition is preferably 10 μm or more and 100 μm or less.

In the present specification, “average fiber diameter” and “average fiber length” of the cellulose nanofibers mean “number average fiber diameter” and “number average fiber length”, respectively. The number average fiber diameter and number average fiber length of cellulose nanofibers can be measured, for example, by observing cellulose nanofibers under a microscope such as an electron microscope or an atomic force microscope.

While there is no particular limitation on the cellulose nanofiber content of the resin composition, it can be 5% by mass or more and 30% by mass or less, for example.

The resin composition prepared in this step s1 is, for example, in pellet form, but may be in other forms. The resin composition containing thermoplastic resin and cellulose nanofibers may be manufactured, for example, by the method to be described below.

Next, the resin composition is dried (step s2: drying process). There is no particular limitation on the method for drying the resin composition and, for example, a dryer can be used to dry the resin composition. For example, the dryer may be a hot-air dryer, a dehumidifying dryer (also called a “dehumidifying hot-air dryer”), or a vacuum dryer.

Then, the resin composition is formed into a resin-molded article (step s3: molding process). This step s3 can be suitably performed by injection molding, for example. Where molding is done by injection molding, the molding temperature and filling pressure may be set appropriately according to the thermoplastic resin used, the content ratio of cellulose nanofibers, etc.

As described above, the manufacturing method according to an embodiment of the present invention includes the step s2 (drying step) in which the resin composition is dried prior to the step s3 (molding step) in which the resin composition is molded into a resin-molded article. As a result, the molding process can be performed after reducing the moisture content of the resin composition, thereby suppressing the generation of silver streaks caused by the moisture contained in the resin composition.

From the viewpoint of more reliably suppressing the generation of silver streaks, it is preferred that the drying process be performed so that the moisture content of the resin composition is sufficiently reduced. Specifically, it is preferred that the drying process be performed so that the moisture content of the resin composition is 400 mass ppm or less, and it is more preferred that the drying process be performed so that the moisture content of the resin composition is 240 mass ppm or less.

From the viewpoint of sufficiently reducing the moisture content of the resin composition, it is preferred that the drying process be performed at a certain temperature or higher, specifically, it is preferred that the drying process be performed at a temperature of 100° C. or higher. It is also preferred that the drying process be performed at a temperature lower than the melting point of the thermoplastic resin contained in the resin composition. For example, where the thermoplastic resin is polypropylene, the drying process should preferably be performed at 150° C. or lower.

From the viewpoint of sufficiently reducing the moisture content of the resin composition, it is preferred that the drying process be performed for a certain amount of time or longer, specifically, it is preferred that the drying process be performed for 1 hour or longer, and it is more preferred that the drying process be performed for 2 hours or longer.

[Results of verification of relationship between moisture content of resin composition and silver streak suppressing effect]

Here, the results of the verification of the correlation between the moisture content of the resin composition and the suppression of the generation of silver streaks by actually making a prototype resin-molded article will be described. The verification was performed as follows.

First, three lots (referred to as “Lot A”, “Lot B”, and “Lot C”) of a resin composition in pellet form, with cellulose nanofibers dispersed in commercially available polypropylene (J-466HP from Prime Polymer), were prepared as the resin composition. The cellulose nanofiber content of the resin composition is 5% by mass. The average fiber diameter and average fiber length of the cellulose nanofibers are about 100 nm and about 100 μm, respectively.

Next, the moisture content was measured after drying the prepared resin compositions under different drying conditions (temperature and time) or without drying. Drying was performed using a box-shaped hot-air dryer with a capacity of 50 kg. Moisture content was measured using a CZA3100 precision moisture meter from CHINO, and mass measurements required for moisture content measurements were done using a precision mass measuring instrument. These measurements were performed on four samples extracted from Lot A (samples #1 to #4), three samples extracted from Lot B (samples #5 to #7), and four samples extracted from Lot C (samples #8 to #11). In Table 2, which will be referenced later, those of sample #1 that were not dried, those that were dried at 80° C. for 4 hours, and those that were dried at 80° C. for 12 hours are denoted with branch numbers as samples #1-1, #1-2, and #1-3, respectively. Other samples #2, #3, and #5 to #11 are similarly denoted with branch numbers.

Each sample was then injection molded to obtain a resin-molded article. A flat mold of 150 mm in length, 120 mm in width, and 3 mm in thickness (gate cross section size is 2 mm×3 mm) was used as the mold for the molding process. An injection molding machine KB80B2 from Kawaguchi Iron Works was used as the molding machine. The injection molding conditions are as shown in Table 1 below. The obtained resin-molded articles were visually observed for the presence of silver streaks.

TABLE 1
Injection molding conditions

| | | |
|---|---|---|
| Cylinder temperature | 220 | °C |
| Mold temperature | 50 | °C |
| Filling time | 1.68 | sec |
| Holding pressure | 354 | kgf/cm² |
| Pressure holding time | 15 | sec |
| Cooling time | 20 | sec |

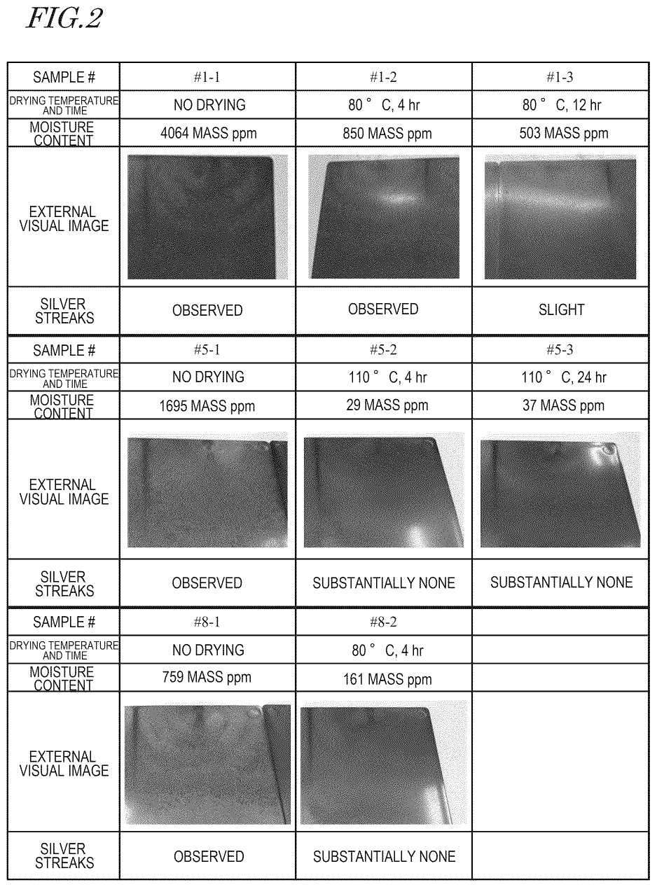

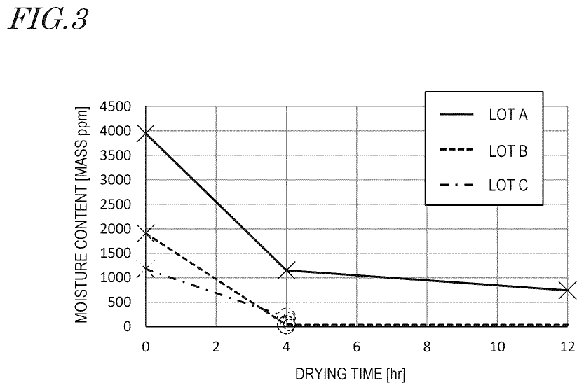

Table 2, Table 3, and Table 4 below show the results of moisture content measurements for these samples. FIG. 2 shows the results of checking for the presence of silver streaks for 8 samples (samples #1-1, #1-2, #1-3, #5-1, #5-2, #5-3, #8-1, and #8-2), along with external visual images. Furthermore, FIG. 3 shows a graph with drying time on the horizontal axis and moisture content on the vertical axis. FIG. 3 plots the average value of samples #1-1, #2-1, and #3-1, the average value of samples #1-2, #2-2, and #3-2, and the average value of samples #1-3, #2-3, #3-3, and #4 for Lot A. FIG. 3 plots the average value of samples #5-1, #6-1, and #7-1, and the average value of samples #5-2, #6-2, and #7-2 for Lot B, and plots the average value of samples #8-1, #9-1, #10-1, and #11-1, and the average value of samples #8-2, #9-2, #10-2, and #11-2 for Lot C. The marker “⊚” in FIG. 3 means that substantially no silver streaks were observed, and the marker “x” means that silver streaks were observed.

TABLE 2

| | | | |
|---|---|---|---|
| | | Drying | |
| | | temperature | Moisture content |
| Lot | Sample number | and time | [Mass in ppm] |

| | | | | |
|---|---|---|---|---|
| A | #1 | #1-1 | No drying | 4064 |
| | | #1-2 | 80 °C, 4 hr | 850 |
| | | #1-3 | 80 °C, 12 hr | 503 |
| | #2 | #2-1 | No drying | 3917 |
| | | #2-2 | 80 °C, 4 hr | 1224 |
| | | #2-3 | 80 °C, 12 hr | 699 |
| | #3 | #3-1 | No drying | 3868 |
| | | #3-2 | 80 °C, 4 hr | 1388 |
| | | #3-3 | 80 °C, 12 hr | 995 |

| | | |
|---|---|---|
| #4 | 80 °C, 12 hr | 771 |
| Average of #1-1, | No drying | 3949 |
| #2-1, #3-1 | | |
| Average of #1-2, | 80 °C, 4 hr | 1154 |
| #2-2, #3-2 | | |
| Average of #1-3, | 80 °C, 12 hr | 742 |
| #2-3, #3-3, #4 | | |

TABLE 3

| | | | |
|---|---|---|---|
| | | Drying | |
| | | temperature | Moisture content |
| Lot | Sample number | and time | [Mass in ppm] |

| | | | | |
|---|---|---|---|---|
| B | #5 | #5-1 | No drying | 1695 |
| | | #5-2 | 110 °C, 4 hr | 29 |
| | | #5-3 | 110 °C, 24 hr | 37 |
| | #6 | #6-1 | No drying | 1943 |
| | | #6-2 | 110 °C, 4 hr | 43 |
| | | #6-3 | 110 °C, 24 hr | 31 |
| | #7 | #7-1 | No drying | 2082 |
| | | #7-2 | 110 °C, 4 hr | 45 |
| | | #7-3 | 110 °C, 24 hr | 41 |

| | | |
|---|---|---|
| Average of #5-1, | No drying | 1906 |
| #6-1, #7-1 | | |
| Average of #5-2, | 110 °C, 4 hr | 39 |
| #6-2, #7-2 | | |
| Average of #5-3, | 110 °C, 24 hr | 36 |
| #6-3, #7-3 | | |

TABLE 4

| | | | |
|---|---|---|---|
| | | Drying | |
| | | temperature | Moisture content |
| Lot | Sample number | and time | [Mass in ppm] |

| | | | | |
|---|---|---|---|---|
| C | #8 | #8-1 | No drying | 759 |
| | | #8-2 | 80 °C, 4 hr | 161 |
| | #9 | #9-1 | No drying | 1511 |
| | | #9-2 | 80 °C, 4 hr | 198 |
| | #10 | #10-1 | No drying | 1175 |
| | | #10-2 | 80 °C, 4 hr | 190 |
| | #11 | #11-1 | No drying | 1270 |
| | | #11-2 | 80 °C, 4 hr | 233 |

| | | |
|---|---|---|
| Average of #8-1, | No drying | 1178 |
| #9-1, #10-1, #11-1 | | |
| Average of #8-2, | 80 °C, 4 hr | 195 |
| #9-2, #10-2, #11-2 | | |

From Table 2, Table 3, Table 4, FIG. 2, and FIG. 3, it can be seen that performing the drying process tends to reduce the moisture content in the resin composition and suppress the generation of silver streaks, and it can be seen that the effect of suppressing the generation of silver streaks is particularly high when the moisture content is 240 mass ppm or less. Note that although FIG. 2 shows only some of the samples, the same trend was observed also for other samples. Specifically, silver streaks occurred in samples #2-1, #2-2, #3-1, #3-2, #6-1, #7-1, #9-1, #10-1, and #11-1, as in samples #1-1, #1-2, #5-1, and #8-1. For samples #2-3, and #3-3, silver streaks occurred slightly as in sample #1-3. In contrast, substantially no silver streaks were observed for samples #6-2, #6-3, #7-2, #7-3, #9-2, #10-2, and #11-2, as in samples #5-2, #5-3, and #8-2. Regarding the drying temperature, it can be seen that a drying temperature of 100° C. or higher can sufficiently reduce the moisture content even when the moisture content of the resin composition in its undried state is relatively high (in other words, the need to strictly manage the moisture content at the stage of preparing the resin composition can be reduced). If the drying temperature is lower than 100° C. (e.g., 80° C.), it may be difficult to sufficiently reduce the moisture content if the moisture content of the resin composition is relatively high, as in Lot A.

The results of a similar verification for another resin composition will now be described.

First, one lot (referred to as “Lot D”) of a resin composition in pellet form (CellenpiaPlas (registered trademark) from Nippon Paper Industries), with cellulose nanofibers dispersed in polypropylene, was prepared as the resin composition. The cellulose nanofiber content of the resin composition is 5% by mass. The average fiber diameter of the cellulose nanofibers is 100 nm or less.

Next, the moisture content was measured after drying the prepared resin compositions under different drying conditions (temperature and time) or without drying. Drying was performed using a box-shaped hot-air dryer with a capacity of 50 kg. Moisture content was measured using a VaporProXL precision moisture meter from Eikoh Seiki, and the mass measurement required for moisture content measurement was performed using a precision mass measuring instrument. These measurements were performed on one sample (sample #12) extracted from Lot D. In Table 6, which will be referenced later, sample #12 without drying is denoted as sample #12-1, and those dried at 110° C. for 0.5, 1, 1.5, 2, 2.5, 3, 3.5, 4, and 4.5 hours are denoted as samples #12-2, #12-3, #12-4, #12-5, #12-6, #12-7, #12-8, #12-9, and #12-10, respectively.

Each sample was then injection molded to obtain a resin-molded article. A flat mold of 150 mm in length, 120 mm in width, and 3 mm in thickness (gate cross section size is 2 mm×3 mm) was used as the mold for the molding process. An electric injection molding machine J80ADS-110U from Japan Steel Works was used as the molding machine. The injection molding conditions are as shown in Table 5 below. The obtained resin-molded articles were visually observed for the presence of silver streaks.

TABLE 5
Injection molding conditions

| | | |
|---|---|---|
| Cylinder temperature | 220 | °C |
| Mold temperature | 50 | °C |
| Filling time | 1.71 | sec |
| Holding pressure | 306 | kgf/cm² |
| Pressure holding time | 15 | sec |
| Cooling time | 20 | sec |

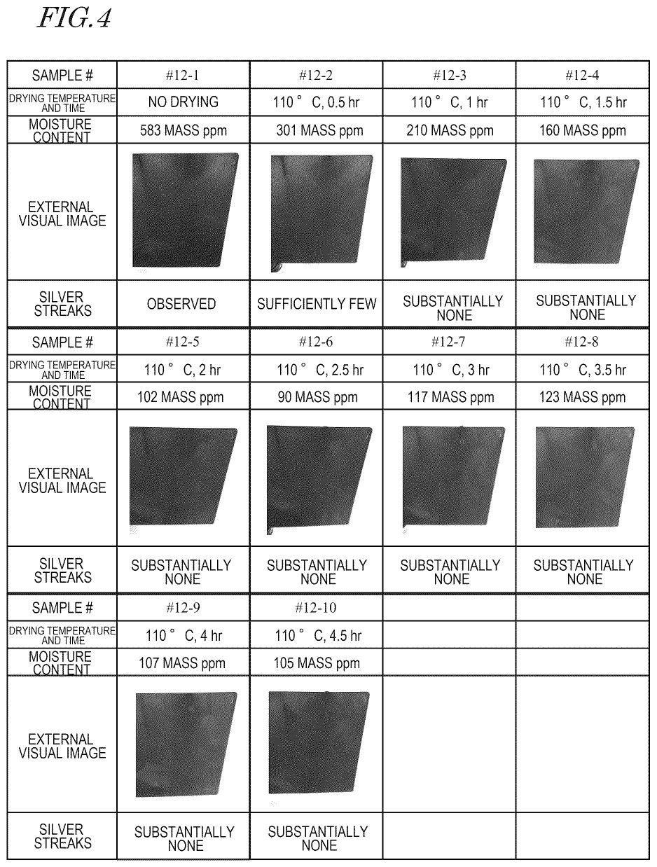

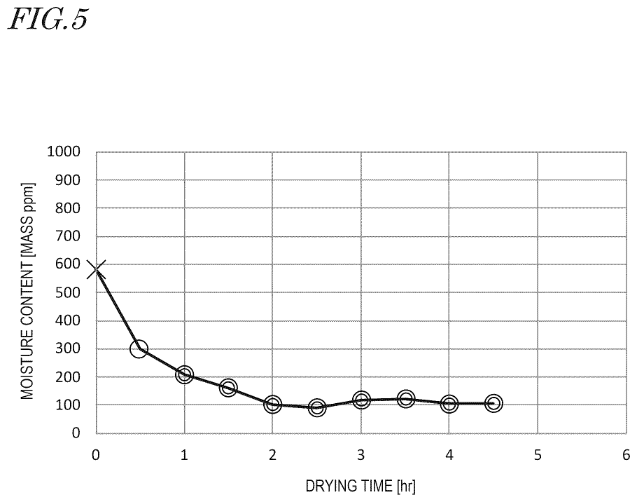

Table 6 below shows the results of moisture content measurements for each sample. FIG. 4 also shows the results of checking for the presence of silver streaks for each sample, along with external visual images. Furthermore, FIG. 5 shows a graph with drying time on the horizontal axis and moisture content on the vertical axis. The marker “⊚” in FIG. 5 means that substantially no silver streaks were observed, the marker “∘” means that sufficiently few silver streaks were observed, and the marker “x” means that silver streaks were observed.

TABLE 6

| | | | |
|---|---|---|---|
| | | Drying | |
| | | temperature | Moisture content |
| Lot | Sample number | and time | [Mass in ppm] |

| | | | | |
|---|---|---|---|---|
| D | #12 | #12-1 | No drying | 583 |
| | | #12-2 | 110 °C, 0.5 hr | 301 |
| | | #12-3 | 110 °C, 1 hr | 210 |
| | | #12-4 | 110 °C, 1.5 hr | 160 |
| | | #12-5 | 110 °C, 2 hr | 102 |
| | | #12-6 | 110 °C, 2.5 hr | 90 |
| | | #12-7 | 110 °C, 3 hr | 117 |
| | | #12-8 | 110 °C, 3.5 hr | 123 |
| | | #12-9 | 110 °C, 4 hr | 107 |
| | | #12-10 | 110 °C, 4.5 hr | 105 |

From Table 6, FIG. 4, and FIG. 5, it can be seen that performing the drying process tends to reduce the moisture content in the resin composition and suppress the generation of silver streaks. It can be also seen that the effect of suppressing the generation of silver streaks is high when the moisture content is 400 mass ppm or less, and the effect of suppressing the generation of silver streaks is particularly high when the moisture content is 240 mass ppm or less.

### [Method for Manufacturing Resin Composition]

There is no particular limitation on the method for manufacturing the resin composition prepared in step s1, and various known methods can be used as the method for manufacturing resin compositions containing cellulose nanofibers.

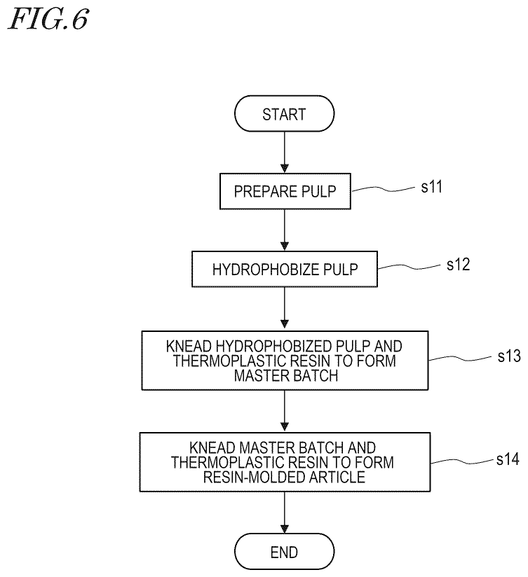

With reference to FIG. 6, an example of a method for manufacturing the resin composition will be described. FIG. 6 is a flow chart showing an example of a method for manufacturing a resin composition.

First, pulp is prepared (step s11). The pulp may be, for example, derived from wood. There is no particular limitation on the species of wood. Various known methods can be used as the method for pulping wood.

Next, hydrophobization treatment is performed on the pulp (step s12). The hydrophobization treatment can increase the compatibility of the cellulose nanofibers and the resin. There is no particular limitation on the method of hydrophobization treatment.

Then, the hydrophobized pulp and the thermoplastic resin are kneaded together to form a master batch (step s13). There is no particular limitation on the method of kneading, and the kneading can be done using a kneader. In this step s13, the pulp is unraveled and the cellulose nanofibers are dispersed in the resin.

The masterbatch and the thermoplastic resin are then kneaded together to form the resin composition (step s14). There is no particular limitation on the method of kneading in this step s14, and the kneading can be done using a kneader. For example, the cellulose nanofiber content of the masterbatch can be about 30% by mass to 45% by mass, and the cellulose nanofiber content of the resin composition obtained by this step s14 can be about 5% by mass to 15% by mass.

With the manufacturing method illustrated in FIG. 6, the unraveling of pulp and the dispersion of cellulose nanofibers in the resin can be done simultaneously, thereby reducing the manufacturing cost. Needless to say, the method for manufacturing the resin composition is not limited to that illustrated in FIG. 6.

### [Resin-Molded Article]

Resin-molded articles obtained by the manufacturing method according to the embodiment of the present invention can be used for various applications as the generation of silver streaks is suppressed. Since a resin-molded article obtained by the manufacturing method according to the embodiment of the present invention is formed from a resin composition containing cellulose nanofibers, it has excellent strength and can be suitably used as a component of various transportation equipment (especially in place of a component formed from a resin composition containing conventional reinforcing fillers such as talc and glass fiber).

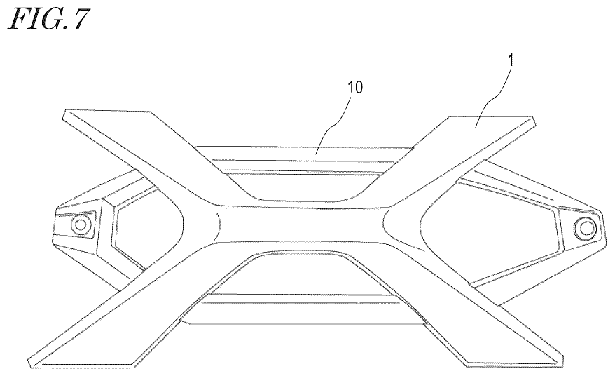

The resin-molded article obtained by the manufacturing method according to the embodiment of the present invention may be, for example, a crossbar member 10 for a watercraft, as shown in FIG. 7. FIG. 7 also shows, in addition to the crossbar member 10, an engine cover 1 which is located on top of the engine. The crossbar member 10 is a member that is attached to the back side of the engine cover 1 to support and reinforce the engine cover 1.

Other resin-molded articles that can be obtained by the manufacturing method according to the embodiment of the present invention include, for example, inner engine hatches and base sheets for watercraft, assist grips and helmet boxes for motorcycles, lower covers and leg shields for scooter-type motorcycles, engine covers for outboard motors, etc.

As described above, a method for manufacturing a resin-molded article according to an embodiment of the present invention is a method for manufacturing a resin-molded article including: a step (A) of preparing a resin composition containing thermoplastic resin and cellulose nanofibers; and a step (B) of molding the resin composition into a resin-molded article, wherein the method further includes, before the step (B), a step (C) of drying the resin composition.

As the manufacturing method according to the embodiment of the present invention includes, before the step (B) of molding the resin composition into a resin-molded article, the step (C) of drying the resin composition, it is possible to perform the step (B) after the moisture content of the resin composition is reduced. Therefore, it is possible to suppress the generation of silver streaks caused by the moisture contained in the resin composition.

In one embodiment, the step (C) is performed so that moisture content of the resin composition is 400 mass ppm or less.

From the viewpoint of more reliably suppressing the generation of silver streaks, it is preferred that the step (C) be performed so that the moisture content of the resin composition is 400 mass ppm or less.

In one embodiment, the step (C) is performed so that moisture content of the resin composition is 240 mass ppm or less.

From the viewpoint of more reliably suppressing the generation of silver streaks, it is more preferred that the step (C) be performed so that the moisture content of the resin composition is 240 mass ppm or less.

In one embodiment, the step (C) is performed at a temperature of 100° C. or higher.

From the viewpoint of sufficiently reducing the moisture content of the resin composition, it is preferred that the step (C) be performed at a certain temperature or higher, specifically, it is preferred that the step (C) be performed at a temperature of 100° C. or higher.

In one embodiment, the step (C) is performed for 4 hours or longer.

From the viewpoint of sufficiently reducing the moisture content of the resin composition, it is preferred that the step (C) be performed for a certain amount of time or longer, specifically, it is preferred that the step (C) be performed for 4 hours or longer.

In one embodiment, the thermoplastic resin is polypropylene.

For example, polypropylene can be suitably used as the thermoplastic resin contained in the resin composition.

In one embodiment, an average fiber diameter of the cellulose nanofibers is 10 nm or more and 100 nm or less.

The average fiber diameter of the cellulose nanofibers contained in the resin composition is preferably 10 nm or more and 100 nm or less.

In one embodiment, an average fiber length of the cellulose nanofibers is 10 μm or more and 100 μm or less.

The average fiber length of the cellulose nanofibers contained in the resin composition is preferably 10 μm or more and 100 μm or less.

### INDUSTRIAL APPLICABILITY

An embodiment of the present invention is a method for manufacturing a resin-molded article using a resin composition containing cellulose nanofibers, wherein it is possible to suppress the generation of silver streaks. A resin-molded article manufactured by using the manufacturing method according to the embodiment of the present invention can be suitably used as a component of various transportation equipment, for example.

### REFERENCE SIGNS LIST

1 Engine cover
10 Crossbar member

1. A method for manufacturing a resin-molded article, comprising:
preparing a resin composition containing thermoplastic resin and cellulose nanofibers;
drying the resin composition; and
subsequently molding the resin composition into the resin-molded article.

2. The method for manufacturing the resin-molded article according to claim 1, wherein at the drying of the resin composition, a moisture content of the resin composition is reduced to 400 mass ppm or less.

3. The method for manufacturing the resin-molded article according to claim 1, wherein at the drying of the resin composition, a moisture content of the resin composition is reduced to 240 mass ppm or less.

4. The method for manufacturing the resin-molded article according to claim 1, wherein the drying of the resin composition is performed at a temperature of 100° C. or higher.

5. The method for manufacturing the resin-molded article according to claim 1, wherein the drying of the resin composition is performed for 1 hour or longer.

6. The method for manufacturing the resin-molded article according to claim 1, wherein the thermoplastic resin is polypropylene.

7. The method for manufacturing the resin-molded article according to claim 1, wherein an average fiber diameter of the cellulose nanofibers is 10 nm or more and 100 nm or less.

8. The method for manufacturing the resin-molded article according to claim 1, wherein an average fiber length of the cellulose nanofibers is 10 μm or more and 100 μm or less.
